(19) United States
(12) Patent Application Publication
(10) Pub. No.: US 2020/0292480 A1
(43) Pub. Date: Sep. 17, 2020

(54) MULTI-GAS SENSING SYSTEM

(71) Applicant: ROYAL MELBOURNE INSTITUTE OF TECHNOLOGY, Melbourne, Victoria (AU)

(72) Inventors: Adam CHRIMES, Melbourne, Victoria (AU); Kyle BEREAN, Melbourne, Victoria (AU); Nam HA, Melbourne, Victoria (AU); Kourosh KALANTAR-ZADEH, Melbourne, Victoria (AU)

(73) Assignee: ROYAL MELBOURNE INSTITUTE OF TECHNOLOGY, Melbourne, Victoria (AU)

(21) Appl. No.: 16/610,678

(22) PCT Filed: May 4, 2018
(86) PCT No.: PCT/AU2018/050413

§ 371 Date: Nov. 4, 2019

(30) Foreign Application Priority Data
May 5, 2017 (AU) 2017901645

(51) Int. Cl. G01N 27/12

(52) U.S. Cl. CPC G01N 27/124

(57) ABSTRACT

Disclosed herein is a method for determining a type and corresponding concentration of at least one gas in a multi-gas mixture, the method including: exposing a gas sensitive element of a gas sensor to the multi-gas mixture; modulating a drive signal supplied to a temperature control element of the gas sensor to cause a temperature of the gas sensitive element to change from an initial temperature; recording a transient impedance response of the gas sensitive element while the temperature of the gas sensitive element changes to obtain a transient impedance response that is characteristic of the multi-gas mixture; using the transient impedance response to determine a type and corresponding concentration of at least one gas in the multi-gas sample from a database including calibration data corresponding to the at least one gas. Also disclosed herein is a method of calibrating a multi-gas sensing system, a multi-gas sensing system, and related methods for determining a type and corresponding concentration of at least one gas in a multi-gas mixture.

### FIELD OF THE INVENTION

The invention relates to methods and systems for determining the type and concentration of one or more gases in a multi-gas mixture.

### BACKGROUND OF THE INVENTION

Prior art gas sensors typically operate by heating the sensing element to a steady state temperature and then taking a reading of steady state impedance of the sensor element. This can cause problems when attempting to detect the presence of multiple different gases in a multi-gas mixture. A number of different solutions have been adopted to address this problem. One option is to utilise a plurality of different gas sensitive elements, each gas sensitive element being sensitive to a different gas species. In this way, the gas sensitive elements will each report the detection of a particular gas. Another option is to utilise gas sensitive elements that are responsive to different gases at different temperatures. In these cases, the gas sensitive elements may be heated to a first steady state temperature to obtain a first steady state impedance indicative of the presence of a first gas, and then heated to a second steady state temperature to obtain a second steady state impedance indicative of the presence of a second gas (and so on). However, both of these options result in devices and methods that are increasingly complicated and expensive, particularly if the number of different gases to be detected is high.

An alternative option is to use another methodology. There are more expensive systems that address the above mentioned issues. However, these methods are generally very high-cost and can be difficult to implement. Examples include spectral analysis systems (spectrometry, infra-red, Raman spectroscopy) and gas chromatography (GC). These systems are very useful in the context of a laboratory environment. However, they are usually bulky, expensive and power hungry. This makes them unsuitable for portable or low-power applications such as portable sensing equipment for mobile devices, ingestibles, emergency service use and defence applications. These types of systems are more suited to laboratory settings, where precision and accuracy are the highest priority.

It is an object of the invention to address or ameliorate at least one of the problems of prior art systems and/or methods.

Reference to any prior art in the specification is not an acknowledgment or suggestion that this prior art forms part of the common general knowledge in any jurisdiction or that this prior art could reasonably be expected to be understood, regarded as relevant, and/or combined with other pieces of prior art by a skilled person in the art.

### SUMMARY OF THE INVENTION

In one aspect of the invention, there is provided a method for determining a type and corresponding concentration of at least one gas in a multi-gas mixture, the method including:

exposing a gas sensitive element of a gas sensor to the multi-gas mixture;

modulating a drive signal supplied to a temperature control element of the gas sensor to cause a temperature of the gas sensitive element to change from an initial temperature;

recording a transient impedance response of the gas sensitive element while the temperature of the gas sensitive element changes to obtain a transient impedance response that is characteristic of the multi-gas mixture;

using the transient impedance response to determine a type and corresponding concentration of at least one gas in the multi-gas sample from a database including calibration data corresponding to the at least one gas.

Prior art systems and methods rely on the steady state response to determine the composition and concentration of gases in a multi-gas mixture. However, this approach has a number of shortcomings. In particular, with this prior art approach it is not possible to determine the composition and concentration of gases in a multi-gas mixture based on a single steady state response using prior art gas sensors. This is because at steady state the responses of various gases in the multi-gas mixture overlap and are indistinguishable. In contrast with this, the inventors have surprisingly found that the transient impedance response can be used to determine the composition and concentration of one or more gases in a multi-gas mixture. The present invention thus provides, in one or more forms, cheap and accurate sensors that can be used to replace, complement, or enhance existing gas sensing systems.

In contrast with prior art sensor systems and methods, the present invention uses the transient impedance response of a gas sensitive element. This transient impedance response provides data regarding one or more gases that are present in a multi-gas mixture as the temperature of the gas sensitive element is raised and lowered (such as due to passive cooling). Characterisation of this data with an appropriate model allows determination of types and concentrations of one or more gases in the multi-gas mixture.

The term “impedance” may include both the resistance and reactance of an electrical circuit, element or combination of thereof. However in some embodiments the impedance measured may solely be resistance, such as if a DC heating pulse is used, or only the resistance is measured.

In certain forms, methods and systems of the invention have reduced hardware requirements and power requirements in comparison with prior art sensors. This is because relying on the transient response means that plural sensors are not necessarily required and/or the methods and systems do not necessarily require heating to multiple steady state temperatures both of which may be required to detect multiple gases in existing systems. Thus in one or more forms, the methods and systems are able to utilise low cost gas sensors which are portable and have very low power requirements (<100 mW) making the methods and systems of the invention useful in portable gas sensing applications, where power availability is restricted, and gas types are initially unknown. Due to the low power requirements, a single sensor can operate for many days from a single battery.

The temperature control element may heat or cool the gas sensitive element. In one embodiment the temperature control element is a cooling element (such as a Peltier cooler), and wherein the modulating step includes modulating the drive signal supplied to the cooling element of the gas sensor to cause cooling of the gas sensitive element from the initial temperature; and the recording step includes recording the transient impedance response of the gas sensitive element during cooling and/or heating of the gas sensitive element to obtain a transient impedance response that is characteristic of the multi-gas mixture. In an alternative embodiment, the temperature control element is a heating element; the modulating step includes modulating the drive signal supplied to the heating element of the gas sensor to cause heating of the gas sensitive element from the initial temperature; and the recording step includes recording the transient impedance response of the gas sensitive element during heating and/or cooling of the gas sensitive element to obtain a transient impedance response that is characteristic of the multi-gas mixture.

In an embodiment the drive signal is a voltage.

In an embodiment, the method further includes deriving a score value from the transient impedance response, and using the score value to determine a type and corresponding concentration of at least one gas in the multi-gas sample from a database including calibration data corresponding to the at least one gas. Preferably, the score value is determined by comparing the transient impedance response with a database of calibration data having corresponding calibration score values, and interpolating the score value using the calibration score values. More preferably, the method further includes subjecting the score value to regression analysis to identify a type of the multi-gas mixture including the at least one gas that corresponds to the score value. Once the type of multi-gas mixture has been identified, the method further includes: identifying a function corresponding to the multi-gas mixture, and using the score value to interpolate the type and concentration of the at least one gas from the function.

In one form of this embodiment, the score value is derived from the transient impedance response using principal component analysis.

In one form of this embodiment, prior to deriving the score value, the method further includes a step of pre-filtering the transient impedance response to remove outlier data.

In an embodiment, the transient impedance response is measured as an analogue signal, and the method further includes converting the analogue signal to a digital signal to obtain the transient impedance response. The step of converting the analogue signal includes sampling the analogue signal at a sampling rate of 40 Hz or greater. Preferably, the sampling rate is less than 100 kHz.

In certain forms of the invention, the step of modulating the drive signal includes providing at least one drive signal pulse. Preferably the pulse has a pulse shape corresponding to one of a square wave, sinusoidal wave, or ramp, although other pulse shapes could be used as desired. It is preferred that the pulse is supplied for a time of 50 ms or less. Preferably, the pulse is applied for 30 ms or less. More preferably, the pulse is applied for 20 ms or less. Most preferably, the pulse is applied for 15 ms or less. Alternatively, or additionally, it is preferred that the pulse is applied for a time of at least 1 ms. More preferably, the pulse is applied for at least 3 ms. Even more preferably the pulse is applied for at least 5 ms. Most preferably, the pulse is applied for at least 10 ms. In embodiments where the drive signal is a voltage, the pulse is a voltage pulse.

Where the voltage is provided as a series of voltage pulses, the step of measuring the transient impedance response of the gas sensitive element is conducted for each repeating pulse of a plurality of repeating pulse in the series of repeating pulses.

In an embodiment, measuring the transient impedance response of the gas sensitive element occurs until the gas sensitive element returns to the initial temperature.

In an embodiment, measuring the transient impedance response of the gas sensitive element continues after the drive signal has ceased being applied for a time of 150 ms or less. Preferably, the measuring is for a time of 120 ms or less. More preferably, the measuring is for a time of 100 ms or less. Even more preferably, the measuring is for a time of 90 ms or less. Most preferably, the measuring is for a time of 85 ms or less. Alternatively, or additionally, it is preferred that the measuring is for a time of at least 50 ms. More preferably, the measuring is for a time of at least 60 ms. Most preferably, the measuring is for a time of at least 70 ms.

In an embodiment, the method is for determining a type and corresponding concentration of two or more gases in a multi-gas mixture.

In one embodiment, the gas sensor is a single element gas sensor. The inventors have found that in some forms of the invention, a single element gas sensors is capable of identifying and quantifying gases in mixtures with a fast (<100 ms) response time and with low power requirements (<100 mW). This enables the gas sensor to provide rapid measurements in almost real-time, with the added benefit of being operable from a portable power source.

In another aspect of the invention there is provided a method of calibrating a multi-gas sensing system, the method including:

(a) exposing a gas sensitive element to a multi-gas mixture including at least two known gases of known concentrations;

(b) modulating a drive signal supplied to a temperature control element of the gas sensor to cause a temperature of the gas sensitive element to change from an initial temperature;

(c) recording a transient impedance response of the gas sensitive element while the temperature of the gas sensitive element changes to obtain calibration data of the transient impedance response that is characteristic of the multi-gas mixture; and

(d) storing the calibration data in a database.

In one embodiment the temperature control element is a cooling element (such as a Peltier cooler), and wherein the modulating step includes modulating the drive signal supplied to the cooling element of the gas sensor to cause cooling of the gas sensitive element from the initial temperature; and the recording step includes recording the transient impedance response of the gas sensitive element during cooling and/or heating of the gas sensitive element to obtain a transient impedance response that is characteristic of the multi-gas mixture. In an alternative embodiment, the temperature control element is a heating element; the modulating step includes modulating the drive signal supplied to the heating element of the gas sensor to cause heating of the gas sensitive element from the initial temperature; and the recording step includes recording the transient impedance response of the gas sensitive element during heating and/or cooling of the gas sensitive element to obtain a transient impedance response that is characteristic of the multi-gas mixture.

In an embodiment the drive signal is a voltage.

In an embodiment, the method further includes deriving a score value from the transient impedance response, and storing the score value in the database. Preferably, principal component analysis is used to derive the score value.

In an embodiment, the method further includes repeating steps (a) to (c) for a plurality of different relative concentrations of the at least two known gases, and storing calibration curves corresponding for each of the plurality of different relative concentrations of the at least two known gases. Preferably, the method further includes deriving score values from a plurality of the calibration data, and storing the score values in the database. Preferably, the method further includes forming a spline model from the score values.

In an embodiment, the method further includes applying a statistical analysis to the transient impedance response to generate the calibration data. Preferably, prior to the statistical analysis, the method further includes pre-filtering the transient impedance response to remove outlier data. In one or more forms, the statistical analysis is principal component analysis.

In an embodiment, the step of modulating the drive signal includes providing the drive signal in a waveform of pulses, square waves, sinusoidal waves, ramp and pseudo-random noise. It is preferred that the drive signal is supplied in the form of a pulse, such as one applied for a time of 50 ms or less. Preferably, the pulse is applied for 30 ms or less. More preferably, the pulse is applied for 20 ms or less. Most preferably, the pulse is applied for 15 ms or less. Alternatively, or additionally, it is preferred that the pulse is applied for a time of at least 1 ms. More preferably, the pulse is applied for at least 3 ms. Even more preferably the pulse is applied for at least 5 ms. Most preferably, the pulse is applied for at least 10 ms. In embodiments where the drive signal is a voltage, the pulse is a voltage pulse.

Where the drive signal is provided in a waveform (such as a voltage waveform), the waveform may be in the form of a series of repeating waves (e.g. repeating pulses, square waves, sine waves, ramps etc). In such instances, the step of measuring the transient impedance response of the gas sensitive element is conducted for each repeating wave of a plurality of repeating waves in the series of repeating waves.

In an embodiment, measuring the transient impedance response of the gas sensitive element, during cooling of the gas sensitive element, is for a time taken for the gas sensitive element to cool to the initial temperature.

In an embodiment, measuring the transient impedance response of the gas sensitive element continues after the drive signal has ceased being applied for a time of 150 ms or less. Preferably, the measuring continues for a time of 120 ms or less. More preferably, the measuring continues for a time of 100 ms or less. Even more preferably, the measuring continues for a time of 90 ms or less. Most preferably, the measuring continues for a time of 85 ms or less. Alternatively, or additionally, it is preferred that the measuring continues for a time of at least 50 ms. More preferably, the measuring continues for a time of at least 60 ms. Most preferably, the measuring continues for a time of at least 70 ms.

In a further aspect of the invention, there is provided a database of calibration model values obtained via the method of calibrating discussed above.

In still another aspect of the invention, there is provided a multi-gas sensing system including:

a gas sensor device including at least:
a gas sensitive element for sensing gases in a multi-gas sample,
a temperature control element for changing the temperature of the gas sensitive element, the temperature control element controllable by modulating a drive signal supplied to the temperature control element,
a data acquisition system configured to record a transient impedance response of the gas sensitive element while the temperature of the gas sensitive element changes to obtain a transient impedance response that is characteristic of the multi-gas mixture; and

wherein the system further includes:

a processor or processors configured to use the transient impedance response to determine a type and corresponding concentration of at least one gas in the multi-gas sample from a database including calibration data corresponding to the at least one gas.

In an embodiment, the temperature control element is a cooling element (such as a Peltier cooler) for cooling the gas sensitive element; and the data acquisition system is configured to record the transient impedance response of the gas sensitive element during cooling or the gas sensitive element and/or during heating of the gas sensitive element. In an alternative embodiment, the temperature control element is a heating element for heating the gas sensitive element; and the data acquisition system is configured to record the transient impedance response of the gas sensitive element during heating or the gas sensitive element and/or during cooling of the gas sensitive element.

In an embodiment, the data acquisition system is configured to digitally sample the transient impedance response to obtain the transient impedance response. Preferably, the data acquisition system is configured to digitally sample the transient impedance response at a sampling rate of 40 Hz or greater. Preferably, the sampling rate is less than 100 kHz.

The processor(s) may be part of the gas sensor device, or may be separate from the gas system device. In embodiments where the processor(s) are separate from the gas sensor, the gas sensor preferably includes communication means (such as a wired or wireless communication gateway) to transmit the transient impedance response of the gas sensitive element to the processor(s). Thus in an embodiment, the processor or processors are remote from the data acquisition system, and the system further includes a communication gateway to transmit the transient impedance response from the data acquisition system to the processor or processors.

In an embodiment, the processor or processors are configured to derive a score value from the transient impedance response, and use the score value to determine a type and corresponding concentration of at least one gas in the multi-gas sample from a database including calibration data corresponding to the at least one gas. Preferably, the processor or processors are configured to derive the score value from the transient impedance response using principal component analysis.

In one form of this embodiment, the system includes at least two processors, a first processor configured to derive the score value from the transient impedance response, and a second processor configured to determine the type and concentration of at least one gas in the multi-gas sample; and

the first processor and the second processor are remote from one another; and

the system further includes a communication gateway for wireless communication between the first processor to the second processor.

In an embodiment, the system further includes the database. In one form, the database is remote from the data acquisition system, and the system further includes a communication gateway from communication between the data acquisition system and the database.

In certain forms of the invention, the system further includes a drive signal function generator to modulate the drive signal. The drive signal function generator can generate a drive signal in the form of one or more drive signal pulses. Preferably the pulse has a pulse shape corresponding to one of a square wave, sinusoidal wave, or ramp.

In an embodiment the drive signal is a voltage.

While the choice of material for the gas sensitive element is dependent, at least in part, on the intended application and environment of the gas sensor; in an embodiment, the gas sensitive element is a metal-oxide element. Metal-oxide elements are useful as they are resistant to contamination, corrosion and degradation; and as such are durable in a wide range of different environments. Thus metal-oxide elements, in addition to providing good sensitivity and gas selectivity, also have a long service life.

In one or more forms the gas sensor device is a small gas sensor device, wherein the material of the gas sensing element has a cross-sectional area of 1 mm² or less and/or with a film thickness 10 micron or less. This is advantageous as it allows the gas sensor device to be installed into an area in a non-invasive manner. Furthermore, small gas sensor devices are able to be incorporated into other devices, such as a hand held device easily. By way of example, the gas sensor may be incorporated into a mobile phone device so that the mobile phone device has gas sensing functionality. In another example, the gas sensor may be contained within a small ingestible capsule. Suitable capsules are described in Australian provisional patent application no. 2016903219 entitled “gas sensor capsule” filed 15 Aug. 2016. The entire contents of Australian provisional patent application no. 2016903219 are herein incorporated by reference.

Furthermore, in one or more forms, the gas sensor is adapted to operate in both aerobic and anaerobic environments, making it suitable for use in monitoring fermentation, anaerobic chemical processes, gas space monitoring (for example, confined space monitoring) as well as many other applications in defence and emergency services where there is a risk of oxygen deprivation. To the inventors' knowledge, gas sensors (particularly those including a single gas sensitive element) that can operate in both aerobic and anaerobic environments have not been previously demonstrated.

In still another aspect of the invention, there is provided a method for determining a type and corresponding concentration of at least one gas in a multi-gas mixture, the method including:

receiving data representative of, or derived from, a transient impedance response from a gas sensitive element of a gas sensor; wherein the data is obtained by:
exposing a gas sensitive element of a gas sensor to the multi-gas mixture;
modulating a drive signal supplied to a temperature control element of the gas sensor to cause a temperature of the gas sensitive element to change from an initial temperature; and
recording a transient impedance response of the gas sensitive element while the temperature of the gas sensitive element changes to obtain a transient impedance response that is characteristic of the multi-gas mixture;

the method further including:

using the data to determine a type and corresponding concentration of at least one gas in the multi-gas sample from a database including calibration data corresponding to the at least one gas.

This aspect of the present invention can be implemented in a computing system located remotely from the gas sensor. For example the gas sensor could be coupled to or incorporated into a field device, whereas the method can be performed using data from the field device at a central computing system. Such a system can in some implementations facilitate the collection and use of calibration datasets larger than can be stored or used by the field device.

In one form the received data can be data directly representing the transient impedance. In other forms the received data can include a score value derived from the transient impedance response.

The field device can communicate with the computer system by any combination of wired or wireless communications channels.

In one preferred form the field device is a smartphone, tablet computing device or other hand held computing device.

In one embodiment the temperature control element is a cooling element (such as a Peltier cooler), and wherein the modulating step includes modulating the drive signal supplied to the cooling element of the gas sensor to cause cooling of the gas sensitive element from the initial temperature; and the recording step includes recording the transient impedance response of the gas sensitive element during cooling and/or heating of the gas sensitive element to obtain a transient impedance response that is characteristic of the multi-gas mixture. In an alternative embodiment, the temperature control element is a heating element; the modulating step includes modulating the drive signal supplied to the heating element of the gas sensor to cause heating of the gas sensitive element from the initial temperature; and the recording step includes recording the transient impedance response of the gas sensitive element during heating and/or cooling of the gas sensitive element to obtain a transient impedance response that is characteristic of the multi-gas mixture.

In an embodiment the drive signal is a voltage.

Further aspects of the present invention and further embodiments of the aspects described in the preceding paragraphs will become apparent from the following description, given by way of example and with reference to the accompanying drawings.

### BRIEF DESCRIPTION OF THE DRAWINGS

FIG. 1 is a flow chart demonstrating processes for sensor calibration and sensor use, showing the inter-related components and the flow of information.

FIG. 2 is a schematic of a typical gas sensor system showing the elements of the gas sensor, the heater voltage supply, a data acquisition system, the computer processing system and a user application.

FIG. 3 shows the voltage measured across the sensor element during a 15 ms heater pulse for different gases (i) H₂ (1% in N₂), (ii) CH₄ (100%), and (iii) H₂S (56 ppm) in (A) 1.7% O₂ environment and (B) 0% O₂ environment.

FIG. 4(A) is a graph showing principal component analysis coefficient vectors (PCA vectors) for the first three dominant principal components for model gas tests in oxygen.

FIG. 4(B) is a graph showing principal component coefficient analysis vectors (PCA vectors) for the first three dominant principal components for model gas tests without oxygen.

FIG. 5(A) is a graph showing principal component (PC) scores for each gas concentration observation with oxygen.

FIG. 5(B) is a graph showing principal component (PC) scores for each gas concentration observation without oxygen.

FIG. 6 are charts illustrating the capability of the system in separating gases in aerobic (1.7% O₂) and anaerobic (0% O₂) environments: (A) Sensor output voltage data for several gas mixtures tested in oxygen and (B) the corresponding calculated concentrations of gases based on the response. (C) Sensor output voltage data for several gas mixtures tested without oxygen and (D) the corresponding calculated concentrations of gases based on the response.

### DETAILED DESCRIPTION OF THE EMBODIMENTS

The invention broadly relates to a multi-gas sensing system, a method of calibrating the multi-gas sensing system, and a method of determining a type and corresponding concentration of at least one gas in a multi-gas sample. The system and method are adapted to sense (that is, determine the type and concentration) of a large number of different gases. Such gases may include, but are not limited to: NOₓ; SOₓ; CO₂; CO; H₂; H₂S; NH₃; O₂; noble gases; halogens; hydrogen halides; volatile hydrocarbons such as alkanes, alkenes, alkynes, alcohols, organic acids (in particular volatile fatty acids), wherein the volatile hydrocarbons may be halogenated.

In various forms of the invention, the multi-gas system operates by modulating the temperature of a gas sensitive element in the presence of a multi-gas sample, sampling a transient output signal from the gas sensitive element as the temperature of the gas sensitive element changes over time, and extracting selective and sensitive data by applying mathematical algorithms to the digitally sampled data. This data can be obtained from a single gas element, but could also be applied to an array of different elements, each providing its own unique information based on its particular gas sensitivities. However, in preferred forms, the gas sensing device includes at least a single gas sensitive element that is capable of sensing a plurality of gases, such as more than one different type of gas.

The present invention has application in a range of different gas sensing systems, such as: micro-element sensors, CMOS sensors, multi-gas sensing, neural network, electronic nose, process monitoring, environmental monitoring, wastewater treatment monitoring, chemical process monitoring, bio-systems monitoring, ingestible sensors and personal monitoring. Systems and methods of the invention can be used in a wide variety of applications, particularly applications that benefit from a low power, portable system for measuring and identifying multiple gases in a multi-gas environment. A non-limiting disclosure of such applications includes:
Industrial applications: plant monitoring; outgassing; power plants; volatile gas monitoring.
Defence applications: personal or personnel safety; bodily data monitoring.
Household appliance: monitoring the build-up of toxic gases in the house, such as carbon monoxide and NO₂
Mobile phones: personal or personnel safety and monitoring; portable breath analysis systems; pollution monitoring.
Environmental monitoring: monitoring the movements and concentrations of gases around cities, from cattle/livestock, from power production facilities as well as many other heavy industries (mining, oil, gas, etc).
Automotive industries: monitoring of cabin air quality, monitoring of vehicle performance, etc.
Aerospace industries: monitoring of cabin air quality, monitoring of vehicle performance, etc.
Chemical and processing industries: monitoring of active chemical processes; personnel safety; community and environment monitoring and safety.
Mining industries: Personnel safety; community and environment monitoring and safety.

In one particular form, the gas sensor is contained within an ingestible gas sensing capsule. This is useful to monitor the gases in the bodies of humans and animals. This application requires low power, but highly sensitive systems. In such cases, the gas sensor is contained within an ingestible capsule. The ingestible capsule is formed from a non-dissolvable material that contains a gas permeable but fluid selective membrane to protect the sensor from stomach acids, bile, or other digestive fluids within a digestive tract of a human or non-human animal (such as sheep, cow, goat, chicken, dog, cat, pig etc.). Permeation of the gaseous constituents through the membrane exposes the sensor to the environment of the digestive track, allowing the sensor to report gases detected in the digestive tract. In such instances, the multi-gas sensor includes wireless communication means (such as a wireless transmitter) to transmit information from the multi-gas sensor to a user interface at a remote location (for example, such as outside the body of the animal).

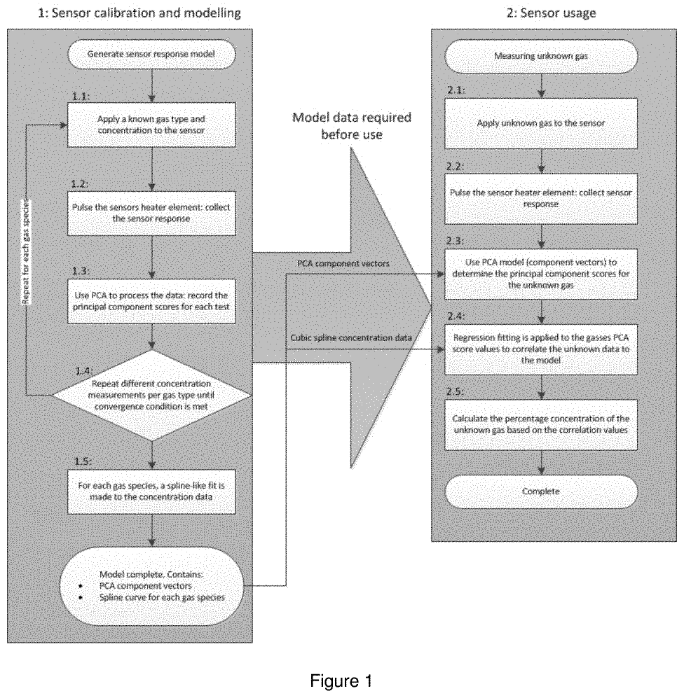

The process for measuring an unknown gas first requires calibration of the multi-gas sensing system using known gases and gas mixtures, and numerical modelling of the calibration data. This process results in unique models for each gas species for a specific gas sensitive element. The basic steps of the modelling process (which is also illustrated under heading 1 in FIG. 1) are as follows:
1.1. Apply a known gas to the sensor
1.2. Operate the temperature control element of the gas sensor and record the transient impedance response of the gas sensitive element in time
1.3. Generate a principal component (PC) model for all recorded calibration data and generate a PC score value
1.4. Repeat steps 1.1-1.3 until the PC model converges (that is, the addition of new observations has an effect on the model that is below a variance threshold)
1.5. For each gas species, a spline curve is fitted to the PC score values to generate a gas concentration vector.

Once an adequate model has been generated, the sensor can then be used for measuring unknown gases. This process (which is illustrated under heading 2 in FIG. 1) is as follows:
2.1. Apply an unknown gas to the sensor
2.2. Operate the temperature control element of the gas sensor and record the transient impedance response of the gas sensitive element in time
2.3. Using the calibration PC model, determine the PC scores for the unknown gas
2.4. Use regression fitting to assign the unknown gas to a spline curve from the model
2.5. Using the information from the curve in step 2.4, calculate a calibrated absolute concentration of the unknown gas by correlating the location of the unknown gas along the model curve.

The process will now be explained in more detail, relating directly to the steps presented above in FIG. 1.

Sensor Calibration and Modelling

1.1: Apply a Known Gas Type and Concentration to the Sensor

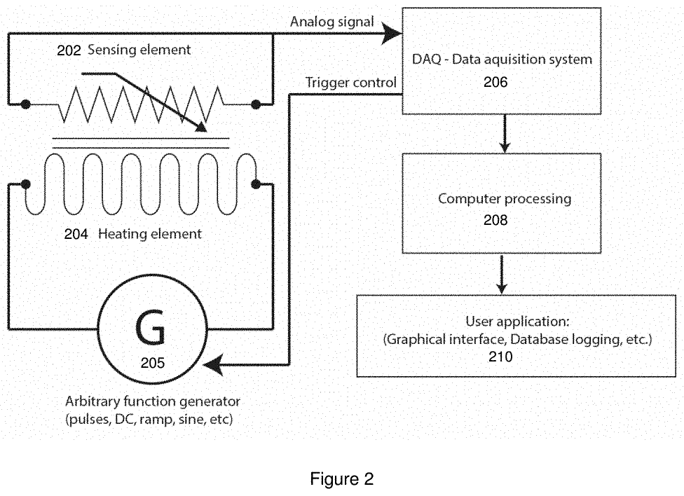

FIG. 2 illustrates a gas sensor 200 that comprises a resistive gas sensitive element 202 and a heating element in the form of a micro-heater 204. The micro-heater 204 and gas sensitive element 202 are in thermal contact with one another. The gas sensitive element 202 is made of conductive electrodes coated in a gas sensitive film. The impedance of the sensing element changes when exposed to different gases at various applied temperatures. The various applied temperatures are modulated using a function generator 205 which applies a voltage to heat the heating element.

Examples of materials that can be used for gas sensitive element 202 are semiconducting metal oxides, such as tin oxides, zinc oxides and tungsten oxides; but many other metal oxides can also be incorporated. Other resistive or semi-conductive elements can be used for the sensing element, such as polymeric materials and graphitic elements; however, these materials may limit the range of heat modulation. The gas sensitive element 202 can also be modified by surface functionalization for improving gas sensitivity and selectivity.

The gas sensitive element 202 can be thick or thin depending on the modulation and response time needed, as well as desired concentration ranges and gas sensitivities. Thicker gas sensitive element materials can improve the sensitivity of the material; however they will have a slower response time compared to thinner materials.

The thickness of the material should be chosen so as to optimise the dynamic response with respect to the gas sensitivity.

The gas sensitive element 202 parameters are measured using a data acquisition system 206, which records the analogue properties of the sensor element and converts them in to a digital signal. The digital signal is used for processing, and determining the gas type and concentration. This can be achieved using a computer processing step 208, which can be operated on any microprocessor, embedded system, mobile device or personal computer system. The information from this process can then be used in a desired user application 210, which may be in any suitable form from a simple graphical user interface (GUI) reading of the immediate gases to complex data logging and monitoring of long term changes.

1.2: Pulse the Sensors Heating Element and Collect the Response

The gas sensitive element 202 provides different sensitivities and responses for various gases, which are directly measured as changes in the impedance of the sensing element. For instance, if the gas sensitive element 202 includes tin oxide, the impedance of the sensing element changes dramatically as it is heated from room temperature up to 400° C. Different gases affect the impedance profile of the gas sensitive element as it is heated and cooled. The invention is generally described in relation to the transient response behaviour of the sensor 200 as it is heated and cooled by applying a pulsed modulation signal to the heating element. However, other signals such as triangular, square, and sinusoidal waves can also be applied to the heating element to provide this transient response. This approach is contrary to current commercial systems, which aim to measure the steady state response of the sensor after thermal equilibrium has been reached, or when a constant voltage or current is applied to the heater.

The micro-heating element 204 of the sensor 200 can be modulated using a voltage pulse, which may be in the form of a sinusoid, a ramp; or a series of voltage pulses, which may be in the form of a sinusoidal wave or pseudo-random noise. The type, magnitude and frequency of the voltage pulses are adjustable, such as with function generator 205, and each combination can provide unique information on the gases present around the sensor. Therefore, the choice of heater voltage for the sensor 200 is important for the desired application, sensor material and target gas.

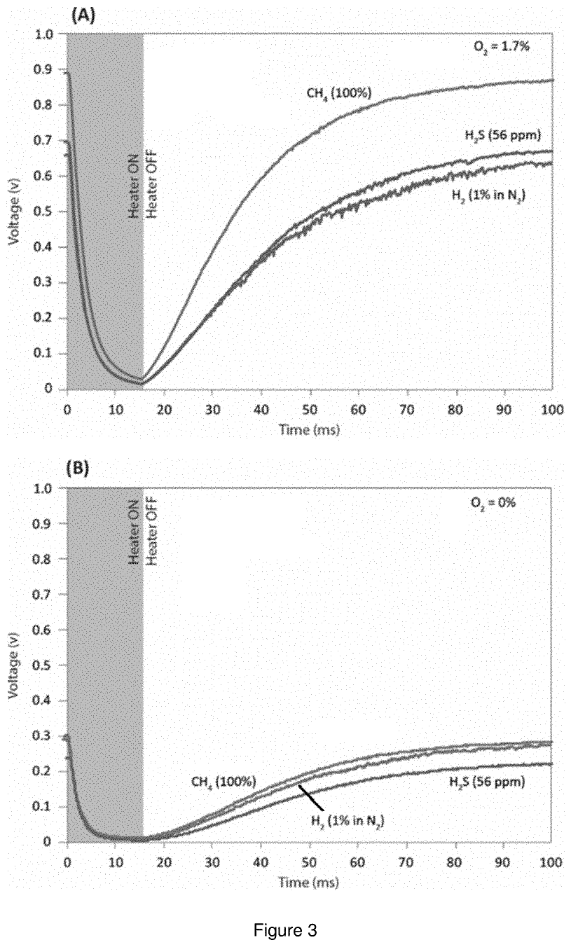

As an example, the micro-heating element 204 was operated with a pulse of several volts applied for 15 milliseconds for three different gases, H₂ (1% in N₂), CH₄ (100%), and H₂S (56 ppm). The resistance change in the gas sensitive element 202 as the heater is turned on and off when measuring each of the gases are recorded until the gas sensitive element 202 has returned to pre-heating equilibrium. FIG. 3 shows the results of the change in voltage measured across the sensor element during a 15 ms heater pulse for different gases (i) H₂ (1% in N₂), (ii) CH₄ (100%), and (iii) H₂S (56 ppm) in (A) 1.7% O₂ environment and (B) 0% O₂ environment. In this example, monitoring of the transient response occurred until the temperature returned to the pre-heating equilibrium temperature, which typically took around 100 ms.

The change in voltage was measured as an analogue signal which was digitised by sampling the analogue signal at an appropriate sampling rate. In this particular example, the sampling rate was 6 kHz, with a digital resolution of 15-bits from a 1.255 V reference voltage. The number of samples over the 100 ms monitoring period is thus 600 samples. The digitised results were then processed using a principal component analysis (PCA) algorithm.

1.3: Use PCA to Process the Data: Record the Principal Component Scores for Each Test

In the present example the transient response of the gas sensitive element, along with post-processing using principal component analysis (PCA) and polynomial curve fitting and correlation, allows identification of types and concentrations of gases in a multi-gas sample. However, other mathematical algorithms can also be employed to extract the specific gas information. To study correlations (including predictive interactions) among gas profiles factor analysis, independent component analysis (ICA) and other methods and corresponding R functions are available. PCA is the preferred method for this, as it provides a simplified model of the data; however an issue with PCA is its poor performance in the presence of outlier data points. This may be overcome using additional algorithms to pre-filter the data to remove these outlier data points.

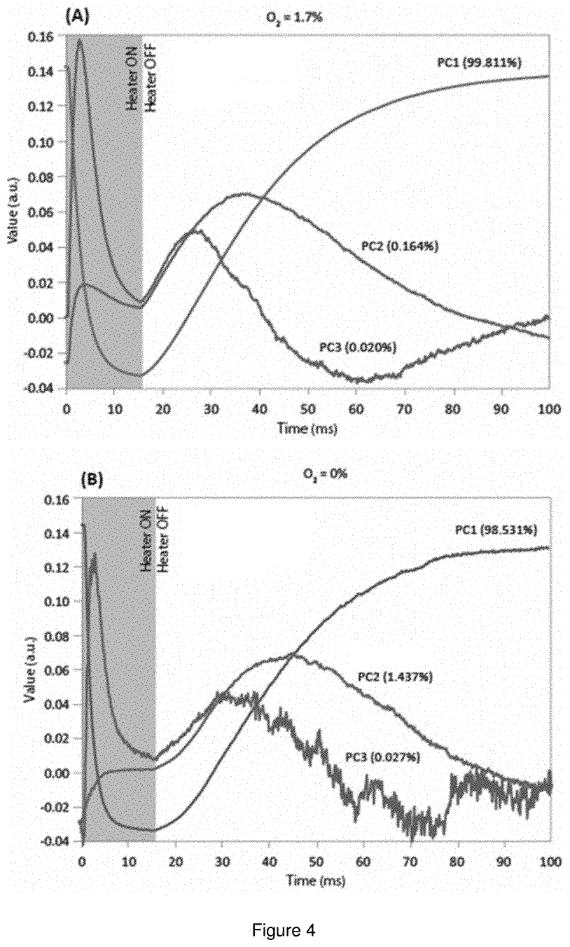

In order to determine the type and concentration of gas detected, the PCA algorithm must be trained by measuring known gases and mixtures. In this example, several gas mixtures of H₂, CH₄ and H₂S are made and used as sensor training data. The PCA algorithm is capable of simplifying 100 ms of raw data down to a series of score values. The score values can be conveniently visualised as a coordinate in three-dimensional (3D) space, which are then used for the calculation of a spline curve to ‘connect-the-dots’ and interpolate for missing observations in the gas sensing model. FIG. 4(A) and FIG. 4(B) illustrate three examples of sensor training data (PC observations), with the sensor detecting H₂, CH₄ and H₂S gases respectively. FIG. 4(A) is a graph showing principal component analysis coefficient vectors (PCA vectors) for the first three dominant principal components for model gas tests (H₂, CH₄ and H₂S) in oxygen, and FIG. 4(B) is a graph showing principal component coefficient analysis vectors (PCA vectors) for the first three dominant principal components for model gas tests (H₂, CH₄ and H₂S) without oxygen.

1.4: Repeat Steps 1-3 Until the PC Model Converges

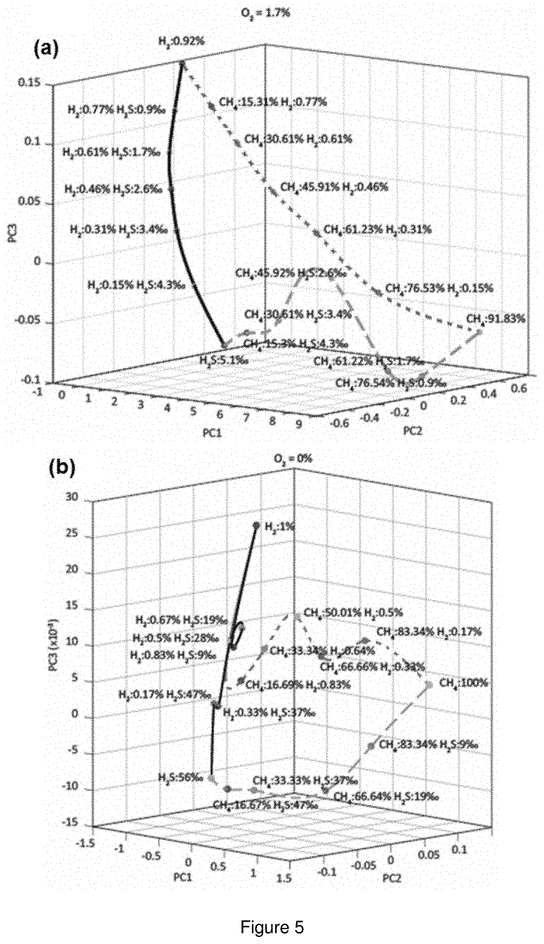

The gas sensor's calibration model must be made robust by repeating the measurements with a large variety of gas types and concentrations. More results included in the model will reduce the error for gas correlation when measuring unknown gases. For this example, each gas mixture was measured at five (5) different concentration values. The scores given to each gas test are shown as points in FIG. 5(A) and FIG. 5(B).

1.5: For Each Gas Species, a Spline Curve is Fitted to the PC Score Values to Generate a Gas Concentration Vector

The process for generating the model must be done individually for each gas concentration and gas type/mixture. Example cubic spline vectors are shown in FIG. 5(A) and FIG. 5(B) for the sensor model data at various concentrations of H₂, CH₄ and H₂S. Three sets of data are shown in each plot for mixtures of CH₄ and H₂, CH₄ and H₂S, and for H₂ and H₂S. The curves are there to ‘connect-the-dots’ between the known measurement points (from the previous step), and to give an estimate for any gases found in-between the known measurement points. This spline curve helps to give a direct relationship between PC score and gas concentration values, and is used for the measurements of unknown gases.

2: Sensor Usage

Using the information obtained from (i) the PCA analyses, (ii) the subsequent gas mixture PCA model and (iii) gas concentration vectors, it is possible to obtain the types and concentrations of gases (for which calibration has been previously done) in an unknown multi-gas mixture.

2.1: Apply an Unknown Gas Type and Concentration to the Sensor

This step is similar to step 1.1, except that the sensing element is exposed to a multi-gas mixture including a gas or gases of unknown types and concentrations.

2.2: Pulse the Sensor's Heating Element and Collect the Response

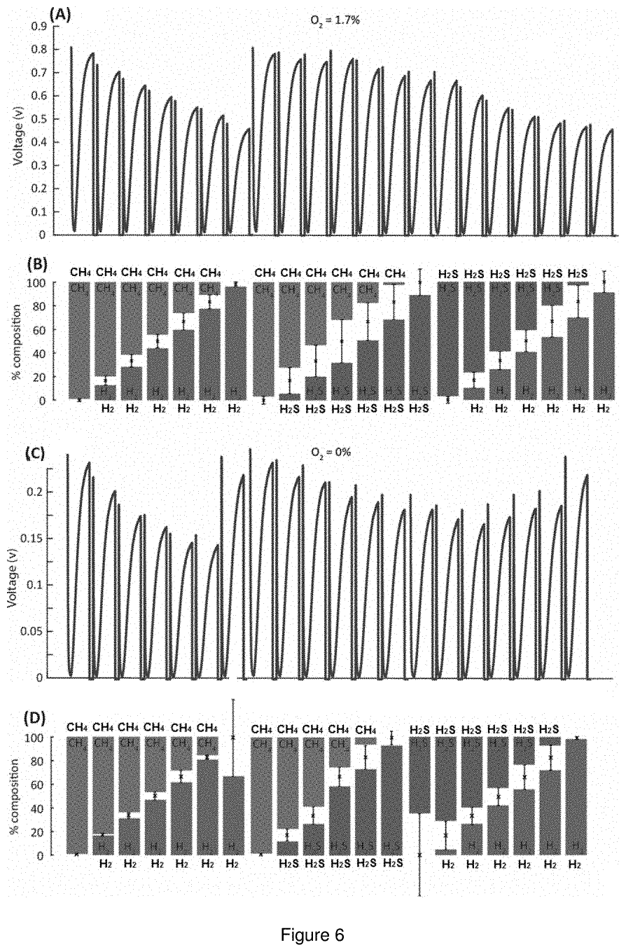

This step is similar to step 1.2. The application of the voltage to the heater element is preferably the same as that used in the calibration phase. FIG. 6(A) and FIG. 6(C) show the sensor response to various gas mixtures in the presence of 1.7% and 0% O₂ respectively.

2.3: Using the Calibration PC Model, Determine the PC Scores for the Unknown Gas

This step relies on the developed PCA model in the calibration phase (step 1.3). For a PCA-based algorithm, the PCA model is a series of principal component curves. Example principal component curves are shown in FIG. 4(A) and FIG. 4(B). The response from the unknown gas is compared to these curves, and a score value is generated for the unknown gas.

2.4: Use Regression Fitting to Assign the Unknown Gas to a Spline Curve from the Model

Regression fitting is then used on the score values of the unknown gas to determine which gas mixture type it belongs to. This step reveals only the type of gas measured.

2.5: Calculate a Calibrated Absolute Concentration of the Unknown Gas by Correlating the Location of the Unknown Gas Along the Model Curve.

This last step is for calculating the concentration of the unknown gas. The spline curves generated from the model are used, where the score values from the unknown gas are compared to the spline curves, and a concentration value for the gas is determined. FIG. 6(B) shows the corresponding calculated concentrations of gases based on the sensor response illustrated in FIG. 6(A), and FIG. 6(D) shows the corresponding calculated concentrations of gases based on the sensor response illustrated in FIG. 6(C).

In this example, tests were repeated 40 times, and the error bars are shown (see FIG. 6(B) and FIG. 6(D)). The error includes sensor error, PCA algorithm error and vector calculation and correlation errors. The errors are all less than 20%—the highest is for separation between CH₄ and H₂S. The error can be improved through more thorough training of the gas sensor model to produce a very good separation of gases in both aerobic and anaerobic environments.

It should be noted that even though the example tin oxide sensor performs poorly in 0% O₂ environments, it was still possible to identify and measure gases. The exceptions appear to be when measuring pure H₂ or pure H₂S, where the error bars are larger. This can be ameliorated, for example, through selection of different materials for the gas sensitive element, or by operating an array of gas sensitive elements.

It will be understood that the invention disclosed and defined in this specification extends to all alternative combinations of two or more of the individual features mentioned or evident from the text or drawings. All of these different combinations constitute various alternative aspects of the invention.

1. A method for determining a type and corresponding concentration of at least one gas in a multi-gas mixture, the method including:
exposing a gas sensitive element of a gas sensor to the multi-gas mixture;
modulating a drive signal supplied to a temperature control element of the gas sensor to cause a temperature of the gas sensitive element to change from an initial temperature;
recording a transient impedance response of the gas sensitive element while the temperature of the gas sensitive element changes to obtain a transient impedance response that is characteristic of the multi-gas mixture;
using the transient impedance response to determine a type and corresponding concentration of at least one gas in the multi-gas sample from a database including calibration data corresponding to the at least one gas.

2. The method of claim 1, further including deriving a score value from the transient impedance response, and using the score value to determine a type and corresponding concentration of at least one gas in the multi-gas sample from a database including calibration data corresponding to the at least one gas.

3. The method of claim 2, wherein the score value is determined by comparing the transient impedance response with a database of calibration data having corresponding calibration score values, and interpolating the score value using the calibration score values.

4. The method of claim 3, wherein, the method further includes subjecting the score value to regression analysis to identify a type of the multi-gas mixture including the at least one gas that corresponds to the score value.

5. The method of claim 4, wherein after the type of multi-gas mixture has been identified, the method further includes: identifying a multivariate spline function corresponding to the multi-gas mixture, and using the score value to interpolate the type and concentration of the at least one gas from the multivariate spline function.

6. The method of any one of claims 2 to 5, wherein the score value is derived from the transient impedance response using principal component analysis.

7. The method of any one of the preceding claims, wherein modulating the drive signal includes providing the drive signal as a pulse, wherein the pulse is applied for a time of 50 ms or less.

8. The method of any one of the preceding claims, wherein measuring the transient impedance response of the gas sensitive element occurs until the gas sensitive element returns to the initial temperature.

9. The method of any one of claims 1 to 8, wherein measuring the transient impedance response of the gas sensitive element continues after the drive signal has ceased being applied for a time of 150 ms or less.

10. The method of any one of the preceding claims, wherein the method is for determining a type and corresponding concentration of two or more gases in a multi-gas mixture.

11. A method of calibrating a multi-gas sensing system, the method including:
(a) exposing a gas sensitive element to a multi-gas mixture including at least two known gases of known concentrations;
(b) applying a modulated drive signal to a temperature control element of the gas sensor to cause a temperature of the gas sensitive element to change from an initial temperature;
(c) recording a transient impedance response of the gas sensitive element while the temperature of the gas sensitive element changes to obtain a calibration curve of the transient impedance response that is characteristic of the multi-gas mixture; and
(d) storing the calibration curve in a database.

12. The method of claim 11, wherein the method further includes deriving a score value from the transient impedance response, and storing the score value in the database.

13. The method of claim 12, wherein principal component analysis is used to derive the score value.

14. The method of any one of claims 11 to 13, wherein the method further includes repeating steps (a) to (c) for a plurality of different relative concentrations of the at least two known gases, and storing calibration data corresponding for each of the plurality of different relative concentrations of the at least two known gases

15. The method of claim 14, wherein the method further includes deriving score values from a plurality of the calibration data, and storing the score values in the database.

16. The method of claim 15, wherein the method further includes forming a spline model from the score values.

17. The method of any one of claims 11 to 16, wherein modulating the drive signal includes providing the drive signal as a pulse, and wherein the pulse is applied for a time of 50 ms or less.

18. A database of calibration model values obtained via the method of calibrating the multi-gas sensor of any one of claims 11 to 17.

19. A multi-gas sensing system including:
a gas sensor device including at least:
a gas sensitive element for sensing gases in a multi-gas sample; and
a temperature control element for changing a temperature the gas sensitive element, the temperature control element controllable by modulating a drive signal supplied to the temperature control element,
wherein the system further includes:
a data acquisition system configured to record a transient impedance response of the gas sensitive element while a temperature of the gas sensitive element changes to obtain a transient impedance response that is characteristic of the multi-gas mixture; and
a processor or processors configured to use the transient impedance response to determine a type and corresponding concentration of at least one gas in the multi-gas sample from a database including calibration data corresponding to the at least one gas.

20. The system of claim 19, wherein the data acquisition system is configured to digitally sample the transient impedance response to obtain the transient impedance response.

21. The system of claim 19 or 20, wherein the processor or processors are configured to derive a score value from the transient impedance response, and use the score value to determine a type and corresponding concentration of at least one gas in the multi-gas sample from a database including calibration data corresponding to the at least one gas.

22. A method for determining a type and corresponding concentration of at least one gas in a multi-gas mixture, the method including:
receiving data representative of, or derived from, a transient impedance response from a gas sensitive element of a gas sensor; wherein the data is obtained by:
exposing a gas sensitive element of a gas sensor to the multi-gas mixture;
modulating a drive signal supplied to a temperature control element of the gas sensor to cause a temperature of the gas sensitive element to change from an initial temperature; and
recording a transient impedance response while the temperature of the gas sensitive element changes to obtain a transient impedance response that is characteristic of the multi-gas mixture;
the method further including:
using the data to determine a type and corresponding concentration of at least one gas in the multi-gas sample from a database including calibration data corresponding to the at least one gas.
